(19) United States
(12) Patent Application Publication
(10) Pub. No.: US 2016/0095032 A1
(43) Pub. Date: Mar. 31, 2016

(54) PLACEMENT AND USE OF WIRELESS NETWORK FUNCTIONS IN A VIRTUALIZATION ENVIRONMENT

(71) Applicant: Douglas W. Varney, Naperville, IL (US)

(72) Inventor: Douglas W. Varney, Naperville, IL (US)

(73) Assignee: ALCATEL-LUCENT USA INC., Murray Hill, NJ (US)

(21) Appl. No.: 14/502,187

(22) Filed: Sep. 30, 2014

(51) Int. Cl. H04W 36/08; H04W 36/30

(52) U.S. Cl. CPC H04W 36/08; H04W 36/30; H04W 88/16

(57) ABSTRACT

A capability for controlling placement and use of wireless network functions within a virtualization environment is presented. The capability for controlling placement and use of wireless network functions in a virtualized environment may include controlling placement of a set of wireless network functions of a wireless network within a virtualization environment to form a set of virtualized wireless network functions, where the set of virtualized wireless network functions includes at least a set of virtualized serving node functions and a set of virtualized gateway node functions. The capability for controlling placement and use of wireless network functions in a virtualized environment may include controlling selection of one of the virtualized gateway node functions responsive to a request for a bearer for a wireless device served by the wireless network.

### TECHNICAL FIELD

The disclosure relates generally to communication networks and, more specifically but not exclusively, to deployment of wireless network functions in a virtualization environment.

### BACKGROUND

In general, wireless network operators using Long Term Evolution (LTE) typically deploy an Evolved Packet Core (EPC) network to support communications between the Evolved NodeBs (eNodeBs) and the packet data networks (e.g., the Internet, private packet data networks, or the like) being used by wireless devices connected to the eNodeBs. It is noted that, while virtualization of the EPC network has been proposed, there are various disadvantages associated with existing mechanisms for virtualization of the EPC network.

### SUMMARY OF EMBODIMENTS

Various deficiencies in the prior art may be addressed by embodiments for controlling placement and use of wireless network functions in a virtualization environment.

In at least some embodiments, an apparatus includes a processor and a memory communicatively connected to the processor. The processor is configured to control placement of a set of wireless network functions of a wireless network within a virtualization environment to form a set of virtualized wireless network functions. The set of virtualized wireless network functions includes at least a set of virtualized serving node functions and a set of virtualized gateway node functions. The processor is configured to control selection of one of the virtualized gateway node functions responsive to a request for a bearer for a wireless device served by the wireless network.

In at least some embodiments, a method is provided. The method includes controlling, via a processor and a memory, placement of a set of wireless network functions of a wireless network within a virtualization environment to form a set of virtualized wireless network functions. The set of virtualized wireless network functions includes at least a set of virtualized serving node functions and a set of virtualized gateway node functions. The method includes controlling selection of one of the virtualized gateway node functions responsive to a request for a bearer for a wireless device served by the wireless network.

In at least some embodiments, a computer-readable storage medium stores instructions which, when executed by a computer, cause the computer to perform a method. The method includes controlling placement of a set of wireless network functions of a wireless network within a virtualization environment to form a set of virtualized wireless network functions. The set of virtualized wireless network functions includes at least a set of virtualized serving node functions and a set of virtualized gateway node functions. The method includes controlling selection of one of the virtualized gateway node functions responsive to a request for a bearer for a wireless device served by the wireless network.

### BRIEF DESCRIPTION OF THE DRAWINGS

The teachings herein can be readily understood by considering the following detailed description in conjunction with the accompanying drawings, in which:

FIG. 1 depicts an exemplary wireless communication system including a management system configured to support placement and use of EPC network functions within a virtualization environment;

FIG. 2 depicts an exemplary embodiment of a method for supporting placement of EPC network functions within a virtualization environment;

FIGS. 3A and 3B depict an example in which the management system of FIG. 1 supports placement of EPC network functions within a virtualization environment in accordance with the method of FIG. 2;

FIG. 4 depicts an exemplary embodiment of a method for supporting use of EPC network functions placed within a virtualization environment;

FIG. 5 depicts an exemplary embodiment of a method for supporting placement and use of wireless network functions of a wireless network within a virtualization environment; and

FIG. 6 depicts a high-level block diagram of a computer suitable for use in performing functions described herein.

To facilitate understanding, identical reference numerals have been used, where possible, to designate identical elements common to the figures.

### DETAILED DESCRIPTION OF EMBODIMENTS

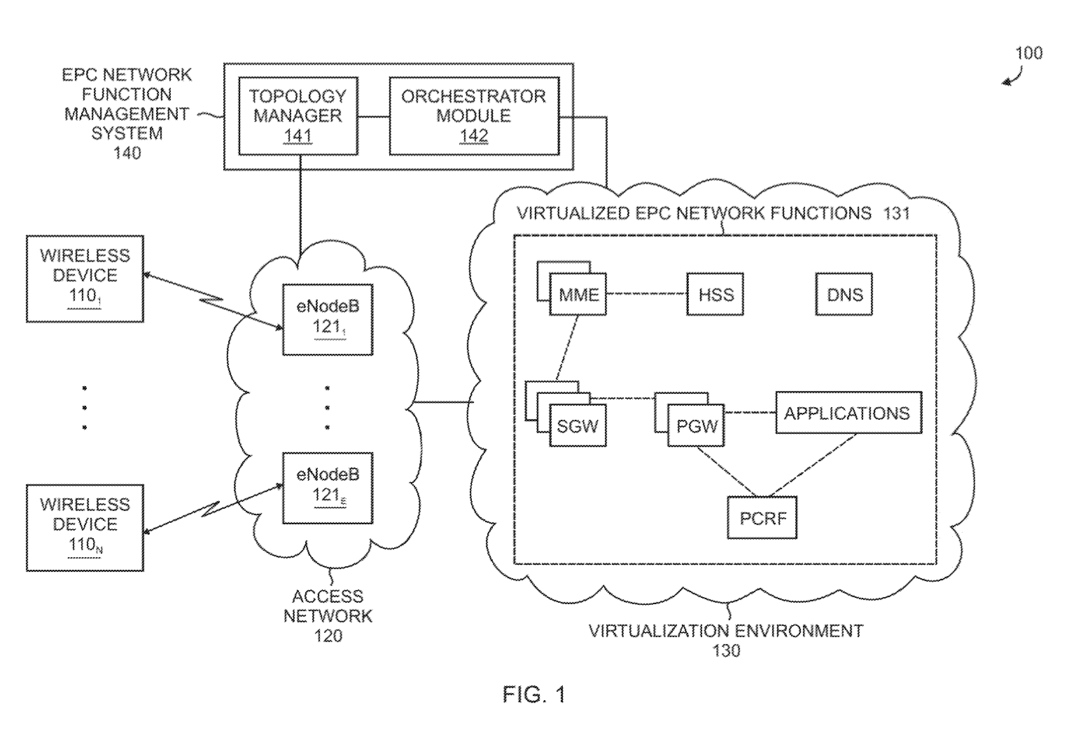

In general, a capability for controlling placement and use of wireless network functions within a virtualization environment is presented. The capability for controlling placement and use of wireless network functions may support placement of wireless network functions in a virtualized environment to provide thereby virtualized wireless network functions. The capability for controlling placement and use of wireless network functions may support use of virtualized wireless network functions to support communications by wireless devices. The wireless network functions, for example, may include wireless network functions of a Third Generation (3G) Universal Mobile Telecommunications System (UMTS) wireless core network, wireless network functions of a Long Term Evolution (LTE) Evolved Packet Core (EPC) network, or wireless network functions of any other suitable type of wireless communication network. These and various other embodiments and advantages of the capability for controlling placement and use of wireless network functions within a virtualization environment may be further understood when considered within the context of an exemplary wireless communication system as depicted in FIG. 1.

FIG. 1 depicts an exemplary wireless communication system including a management system configured to support placement and use of EPC network functions within a virtualization environment.

In the example illustration, the wireless communication system 100 is a Long Term Evolution (LTE) based wireless communication system configured to use EPC network functions for supporting communications.

The wireless communication system 100 includes a plurality of wireless devices (WDs) 110₁-110_{N} (collectively, WDs 110), an access network (AN) 120, a virtualization environment (VE) 130, and an EPC network function management system (ENFMS) 140.

The WDs 110 include wireless devices configured to wirelessly access AN 120 and to communicate via AN 120. It will be appreciated that, within the context of an LTE-based wireless communication system such as wireless communication system 100, the WDs 110 also may be referred to as User Equipments (UEs). For example, the WDs 110 may include smartphones, tablet computers, laptop computers, Internet of Things (loT) devices, or the like.

The AN 120 is an access network providing wireless access for WDs 110 and configured to support communications by WDs 110. The AN 120 includes a plurality of eNodeBs 121₁-121_{E} (collectively, eNodeBs 121) configured to operate as wireless access nodes for WDs 110. The AN 120 may include traffic distribution capabilities for distributing downstream traffic intended for delivery to WDs 110, traffic aggregation capabilities for aggregating upstream traffic received from WDs 110, or the like, as well as various combinations thereof (omitted from FIG. 1 for purposes of clarity). For example, in additional to eNodeBs 121, AN 120 may include a mobile backhaul transport network including Cell Site Gateway (CSG) nodes associated with eNodeBs 121, Mobile Aggregation Site Gateways (MASGs) connecting to a network providing EPC network functions, or the like, as well as various combinations thereof (although, again, such elements have been omitted from FIG. 1 for purposes of clarity). For example, in additional to eNodeBs 121, AN 120 may include routers, switches, or the like, as well as various combinations thereof (although such elements have been omitted from FIG. 1 for purposes of clarity). The typical configuration and operation of an access network including eNodeBs, such as AN 120 including eNodeBs 121, will be understood by one skilled in the art.

The VE 130 is a virtualization environment configured to support virtualized functions, including virtualized EPC network functions 131.

The VE 130 may include one or more datacenters. The VE 130 may include various types of physical resources which may be used to support virtualized functions. For example, VE 130 may include processing resources (e.g., central processing unit (CPU) resources), memory resources (e.g., Random Access Memory (RAM) resources), storage resources (e.g., disk-based storage, Storage Area Networks (SANs), or the like), input/output networking resources, network resources supporting communications between elements of VE 130 and between elements of VE 130 and elements outside of VE 130, or the like, as well as various combinations thereof. The physical resources of the VE 130 may be provided as Virtual Machines (VMs), which may be created within and removed from VE 130 dynamically. The physical resources of the VE 130 may be provided in various other forms. The virtualized EPC network functions 131 are virtualized versions of the corresponding EPC network functions typically deployed as a physical EPC network. For example, as depicted in FIG. 1, the virtualized EPC network functions 131 may include Serving Gateways (SGWs), Packet Data Network (PDN) Gateways (PGWs), Mobility Management Entities (MMEs), Home Subscriber Servers (HSSs), Domain Name Servers (DNSs), Policy and Charging Rules Functions (PCRFs), or the like, as well as various combinations thereof. The types of EPC network functions typically included within a physical EPC network, and typical configuration of EPC network functions of a physical EPC network, will be understood by one skilled in the art. For example, although Third Generation Partnership Project (3GPP) specifications do not specify the physical relationships between EPC network functions, EPC network functions supporting propagation of bearer traffic are typically arranged in a tree-like arrangement (e.g., one or more PGWs, each PGW serving a set of multiple SGWs, and each SGW serving a set of multiple eNodeBs 121). The virtualized EPC network functions 131 are provided within VE 130 using the resources of VE 130 (e.g., one or more of VMs, CPUs, RAMs, disks, SANs, or the like, as well as various combinations thereof) as discussed further below.

It will be appreciated that, although primarily presented with respect to a direct connection between AN 120 and VE 130, AN 120 and VE 130 may be connected via one or more additional communication networks. For example, physical EPC elements are often deployed as elements connected to a core network providing core underlying communication infrastructure and, thus, it will be appreciated that, as noted above, communication between the AN 120 and the VE 130 may be via one or more additional communication networks (e.g., additional forms of underlying communication infrastructure which may support communication between AN 120 and various virtualized EPC network functions 131 provided within VE 130).

The ENFMS 140 is configured to control placement and use of EPC network functions within VE 130. The ENFMS 140 includes a Topology Manager 141 and an Orchestrator Module 142. It will be appreciated that, although primarily depicted and described with respect to embodiments in which the Topology Manager 141 and the Orchestrator Module 142 form part of a system (namely, ENFMS 140), the Topology Manager 141 and the Orchestrator Module 142 may be integrated into one or more existing systems to support the placement and use of EPC network functions within VE 130, implemented as standalone systems configured to communicate with each other to support the placement and use of EPC network functions within VE 130, or the like, as well as various combinations thereof.

The Topology Manager 141 is configured to obtain network topology information associated with AN 120, obtain cost information associated with AN 120 (or other networks associated with the EPC network), and process the network topology information and the cost information to provide a cost-based topology view for AN 120. The network topology information may describe network topology of various elements of AN 120 (e.g., eNodeBs 121, routers, switches, Layer 2 (L2) connectivity between elements, Layer 3 (L3) connectivity between elements), or the like, as well as various combinations thereof). The network topology information may include, or be obtained from, one or more of Border Gateway Control Protocol (BGCP) messages, Internet Control Message Protocol (ICMP) messages, Multiprotocol Label Switching (MPLS)/Resource Reservation Protocol (RSVP) data and statistics, Simple Network Management Protocol (SNMP) traps, Application Programming Interfaces (APIs), or the like, as well as various combinations thereof. The Topology Manager 141 may maintain a topology view of AN 120 based on the network topology information. The cost information may include provisioned bandwidth information, latency information, or the like, as well as various combinations thereof. In at least some embodiments, for example, the Topology Manager 141 may be implemented based on the Alcatel Lucent 5650 Control Plane Assurance Manager (CPAM) and the Alcatel Lucent 5620 Service Aware Manager (SAM) products.

The Orchestrator Module 142 is configured to support placement and use of EPC network functions within VE 130.

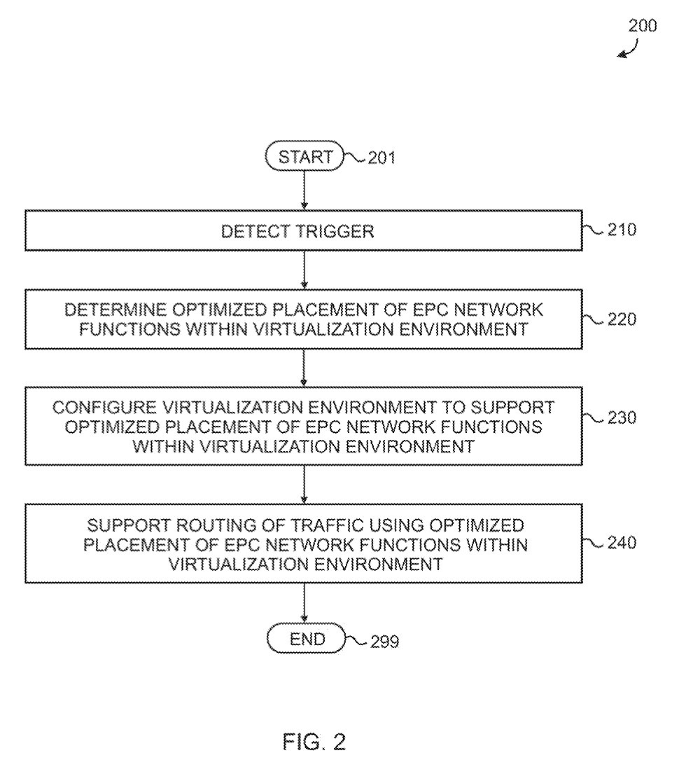

The Orchestrator Module 142 is configured to support placement of EPC network functions within VE 130. The Orchestrator Module 142 may be configured to support placement of EPC network functions within VE 130 based on detection of a trigger condition. The Orchestrator Module 142 may be configured to support placement of EPC network functions within VE 130 by determining an optimized placement of EPC network functions within VE 130 and controlling configuration of VE 130 to support the optimized placement of EPC network functions within VE 130. The Orchestrator Module 142 may determine the optimized placement of EPC network functions within VE 130 based on EPC network requirements to be satisfied by the EPC network functions, information associated with potential placement locations for the EPC network functions (which may include resource characteristics of the potential placement locations for the EPC network functions), resource requirements for the EPC network functions, cost information associated with placement of EPC network functions within VE 130, or the like, as well as various combinations thereof. The EPC network requirements to be satisfied by the EPC network functions may include capacity requirements of each of the EPC network functions to be supported (e.g., 5 units of PGW capacity, 3 units of SGW capacity, 9 units of MME capacity, and so forth). The information associated with potential placement locations for the EPC network functions may include potential datacenters or equipment within datacenters which may host EPC network functions, information indicative of amounts of resources of VE 130 available at potential placement locations for the EPC network functions, or the like, as well as various combinations thereof. For example, information indicative of amounts of resources of VE 130 available at a potential placement location may include information indicative of an amount of available processing resources (e.g., an indication that 22 units of 8CPU processing capability are available), information indicative of an amount of available memory (e.g., 32 GB of RAM), information indicative of an amount of disk space (e.g., 1 SAN with 1.2 TB of disk space), or the like, as well as various combinations thereof. The resource requirements for the EPC network functions may include, for each of the EPC network functions to be supported, one or more virtualization profiles which indicate an amount of resources of VE 130 needed to support an associated capacity of the EPC network function to be supported (e.g., a profile indicative that 1 unit of PGW capacity requires 1 unit of 4CPU processing capability, 8 GB of RAM, and 16 GB of disk; a profile indicative that 4 units of PGW capacity require 1 unit of 8CPU processing capability, 8 GB of RAM, and 32 GB of disk; a profile indicative that 1 unit of MME capacity requires 1 unit of 2CPU processing capability, 4 GB of RAM, and 16 GB of disk; and so forth). It is noted that the references to X units of Y-CPU processing capability may refer to X number of elements each including Y number of CPUs (e.g., X server racks each including Y CPUs, X servers each including Y CPUs, a combination of N server racks each including Y CPUs and X-N servers each including Y CPUs, or the like). The cost information associated with placement of EPC network functions within VE 130 may include cost-based topology information for AN 120, costs associated with use of resources of VE 130, or the like, as well as various combinations thereof. The Orchestrator Module 142 may obtain cost-based topology information for AN 120 from Topology Manager 141 (e.g., using the Application Layer Traffic Optimization (ALTO) protocol or any other suitable protocol). The Orchestrator Module 142 may control configuration of VE 130 to support the optimized placement of EPC network functions within VE 130 by determining a current placement of EPC network functions within VE 130, comparing the optimized placement of EPC network functions within VE 130 and the current placement of EPC network functions within VE 130, and configuring the VE 130 to support the optimized placement of EPC network functions within VE 130 based on the comparison of the optimized placement of EPC network functions within VE 130 and the current placement of EPC network functions within VE 130. The configuration of VE 130 to support the optimized placement of EPC network functions within VE 130 may include creating or instantiating new resource elements, removing existing resource elements, reserving resources, terminating existing resource reservations, or the like, as well as various combinations thereof (e.g., creating new VMs, removing existing VMs, reserving disk resources, terminating reservation of disk resources, reserving SAN resources, terminating reservation of SAN resources, or the like, as well as various combinations thereof). The Orchestrator Module 142 may determine an optimized placement of EPC network functions within VE 130 and control configuration of VE 130 to support the optimized placement of EPC network functions within VE 130 by determining a set of candidate configurations for placement of EPC network functions within VE 130 (e.g., based on EPC network requirements to be satisfied by the EPC network functions (e.g., capacity requirements of each of the EPC network functions to be supported), information associated with potential locations for the EPC network functions (which may include resource characteristics of the potential locations for the EPC network functions), resource requirements for the EPC network functions, or the like, as well as various combinations thereof), evaluating the candidate configurations for placement of EPC network functions within VE 130 (e.g., based on cost information associated with the candidate configurations for placement of EPC network functions within VE 130, which may include cost-based topology information for AN 120, costs associated with use of resources of VE 130, or the like, as well as various combinations thereof), selecting one of the candidate configurations for placement of EPC network functions within VE 130, and controlling configuration of VE 130 to support the selected candidate configuration for placement of EPC network functions within VE 130. The Orchestrator Module 142 may be configured to support placement of EPC network functions within VE 130 by determining a placement of the EPC network functions onto physical resources of VE 130 and configuring the VE 130 based on the placement of EPC network functions onto the physical resources of VE 130. An exemplary embodiment of a method by which Orchestrator Module 142 may support placement of EPC network functions within VE 130 is depicted and described with respect to FIG. 2.

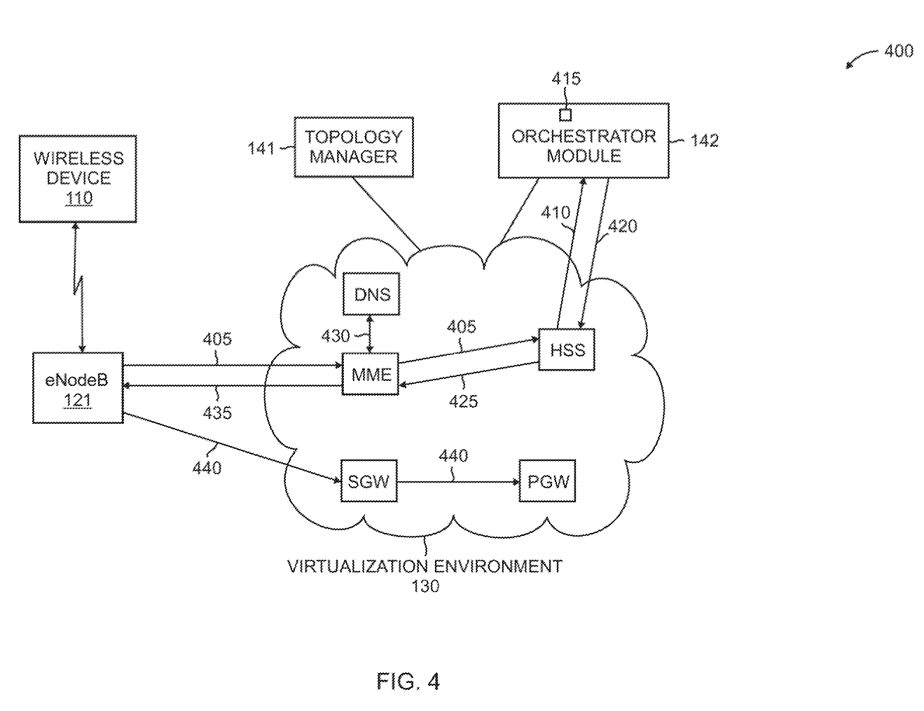

The Orchestrator Module 142 may be configured to support use of EPC network functions within VE 130. The Orchestrator Module 142 may be configured to support use of EPC network functions within VE 130 for routing of traffic of the EPC network (e.g., routing of traffic of WDs 110). The Orchestrator Module 142 may be configured to support use of EPC network functions within VE 130 for routing of traffic of the EPC network by interfacing with one or more of the EPC network functions or other elements supporting the EPC network functions. For example, the Orchestrator Module 142 may interface with an HSS in order to provide PGW addresses to be used by traffic flows supported by the EPC network, thereby enabling steering of traffic flows to PGWs (which may be the optimum PGWs for the traffic). For example, the Orchestrator Module 142 may respond to queries from the MME regarding which SGW and PGW are to be used by traffic flows supported by the EPC network. For example, the Orchestrator Module 142 may respond to queries from the DNS regarding which SGW and PGW are to be used by traffic flows supported by the EPC network. The Orchestrator Module 142 may be configured to support use of EPC network functions within VE 130 by using context information (e.g., user context information, network context information, or the like) to determine PGWs to be used by traffic flows supported by the EPC network. An exemplary embodiment of a method by which Orchestrator Module 142 may support use of EPC network functions within VE 130 for routing of traffic of the EPC network is depicted and described with respect to FIG. 4.

The ENFMS 140 is configured to provide various other functions for controlling placement and use of EPC network functions within VE 130.

FIG. 2 depicts an exemplary embodiment of a method for supporting placement of EPC network functions within a virtualization environment. It will be appreciated that, although presented as being performed serially, at least a portion of the steps of method 200 may be performed contemporaneously or in a different order than as presented in FIG. 2.

At step 201, method 200 begins.

At step 210, a trigger is detected. The trigger may be a change in network topology (e.g., a failure condition impacting network topology, the addition of new fiber to a cell site, the change of backhaul technology to a different technology (e.g., microwave), availability of a new datacenter, or the like), a change in network cost, a change in traffic (e.g., traffic volume, traffic patterns, or the like), a change related to individual user context of one or more users, a periodic timer, or the like, as well as various combinations thereof.

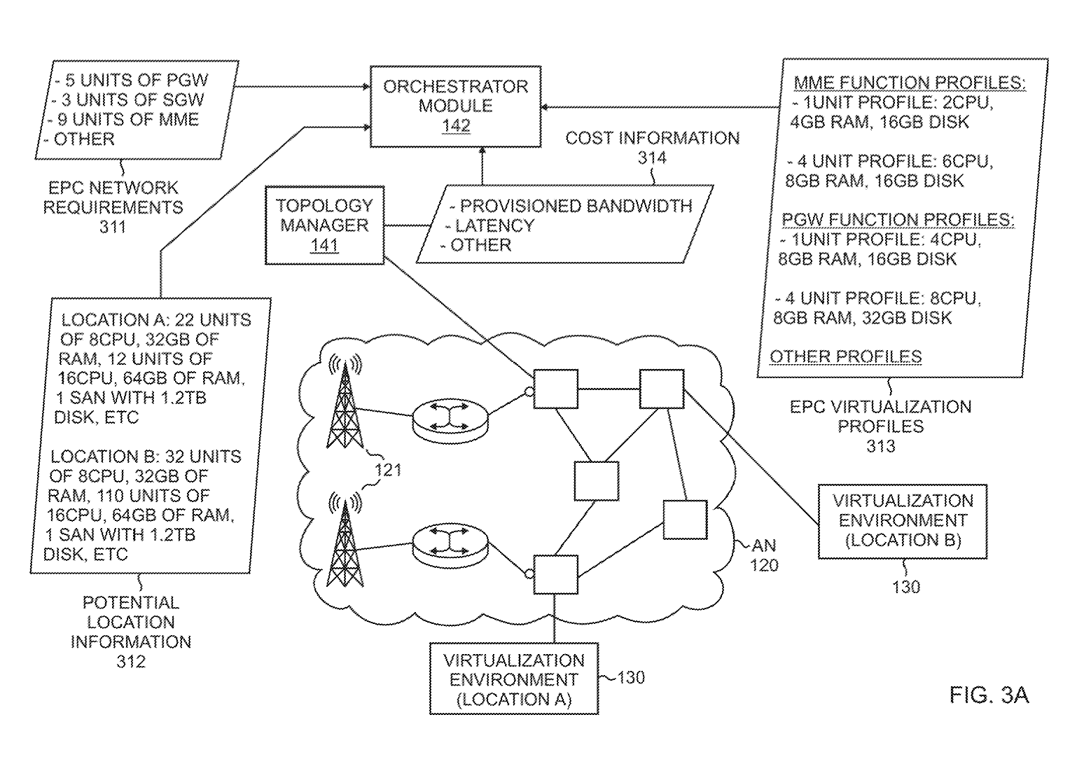

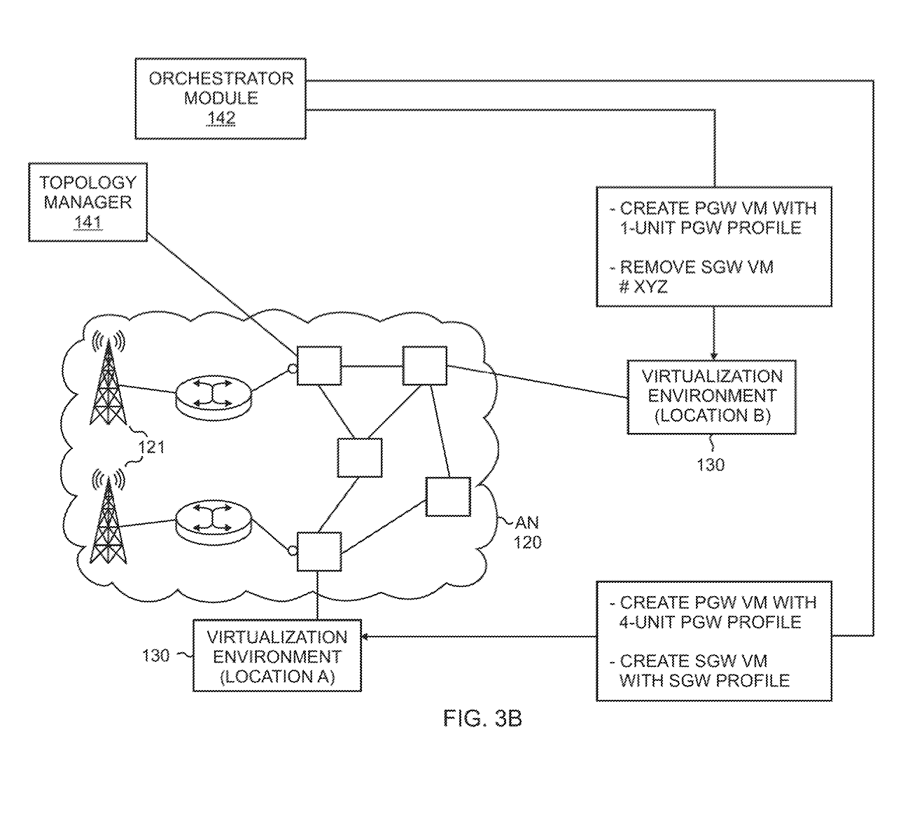

At step 220, an optimized placement of EPC network functions within the virtualization environment is determined. The optimized placement of EPC network functions within the virtualization environment may be optimized with respect to cost, performance, or the like, as well as various combinations thereof. The optimized placement of EPC network functions within the virtualization environment may be determined based on EPC network requirements to be satisfied by the EPC network functions, information associated with potential placement locations for the EPC network functions (which may include resource characteristics of the potential placement locations for the EPC network functions), EPC virtualization profiles for EPC network functions (wherein the EPC virtualization profiles for the EPC network functions indicate resource requirements for particular types of EPC network functions), cost information associated with placement of EPC network functions within the virtualization environment, or the like, as well as various combinations thereof. The optimized placement of EPC network functions within the virtualization environment may be determined by (1) determining candidate placements of EPC network functions within the virtualization environment based on EPC network requirements to be satisfied by the EPC network functions and potential location information for potential locations for the EPC network functions (and associated characteristics of virtualization resources available at the potential locations for the EPC network functions) and (2) selecting one of the candidate placements of EPC network functions within the virtualization environment based on evaluation of the candidate placements of EPC network functions within the virtualization environment wherein evaluation of the candidate placements of EPC network functions within the virtualization environment is based on cost information. The optimized placement of EPC network functions within the virtualization environment may be determined by (1) determining candidate placements of EPC network functions within the virtualization environment based on EPC network requirements to be satisfied by the EPC network functions, EPC virtualization profiles for EPC network functions (wherein the EPC virtualization profiles for the EPC network functions indicate resources necessary to support particular types of EPC network functions), and potential location information for potential locations for the EPC network functions (and associated characteristics of virtualization resources available at the potential locations for the EPC network functions) and (2) selecting one of the candidate placements of EPC network functions within the virtualization environment based on evaluation of the candidate placements of EPC network functions within the virtualization environment wherein evaluation of the candidate placements of EPC network functions within the virtualization environment is based on cost information. The optimized placement of EPC network functions within the virtualization environment may be determined by determining EPC network requirements to be satisfied by the EPC network functions, determining EPC virtualization profiles for EPC network functions (wherein the EPC virtualization profiles for the EPC network functions indicate resources necessary to support particular types of EPC network functions), determining virtualization resources necessary to support the EPC network requirements to be satisfied by the EPC network functions based on the EPC virtualization profiles for the EPC network functions, and determining optimized placement of the virtualization resources necessary to support the EPC network requirements to be satisfied by the EPC network functions based on potential location information for potential locations for the EPC network functions (and associated characteristics of virtualization resources available at the potential locations) and cost information. The optimization of placement of EPC network functions within the virtualization environment (e.g., optimized with respect to cost, performance, or the like, as well as various combinations thereof) may be based on one or more objective optimization techniques (e.g., a single objective optimization technique, a multi-objective optimization technique, or the like) wherein the one or more objective optimization techniques may be based on one or more objective functions (e.g., minimized bandwidth cost, minimized energy cost, minimized server capacity, minimized latency, minimized operational cost, or the like). The optimization of placement of EPC network functions within the virtualization environment (e.g., optimized with respect to cost, performance, or the like, as well as various combinations thereof) may be based on one or more objective optimization techniques (e.g., a single objective optimization technique, a multi-objective optimization technique, or the like) wherein the one or more objective optimization techniques may be based on one or more objective functions (e.g., minimized bandwidth cost, minimized energy cost, minimized server capacity, minimized latency, minimized operational cost, or the like) and one or more constraint functions (e.g., total bandwidth available (e.g., between locations), server capacity available (e.g., at each location and by type), network element limitations, or the like). Various combinations of such optimization objectives and constraints may be used to determine optimized placement of EPC network functions within the virtualization environment. Various embodiments may be further understood by way of reference to FIG. 1 and the example of FIG. 3A.

At step 230, the virtualization environment is configured to support the optimized placement of EPC network functions within the virtualization environment. The configuration of the virtualization environment to support the optimized placement of EPC network functions within the virtualization environment may include determining a current placement of EPC network functions within the virtualization environment, comparing the optimized placement of EPC network functions within the virtualization environment and the current placement of EPC network functions within the virtualization environment, and configuring the virtualization environment to support the optimized placement of EPC network functions within the virtualization environment based on the comparison of the optimized placement of EPC network functions within the virtualization environment and the current placement of EPC network functions within the virtualization environment. The configuration of the virtualization environment to support the optimized placement of EPC network functions within the virtualization environment also may be based on information describing or associated with existing physical EPC network functions (e.g., where EPC network functions are being migrated from physical EPC nodes into the virtualization environment). The modification of the current placement of the EPC network functions within the virtualized environment to conform to the determined optimized placement of the EPC network functions within the virtualized environment may be performed using one or more migration mechanisms to support migration of traffic in a manner tending to prevent impacts to traffic of the EPC network. Various embodiments may be further understood by way of reference to FIG. 1 and the example of FIG. 3B.

At step 240, routing of traffic, using the optimized placement of EPC network functions within the virtualization environment, is supported. The routing of traffic using the optimized placement of EPC network functions within the virtualization environment may include selection of virtualized EPC network functions to support traffic flows of wireless devices served by the EPC network. The routing of traffic using the optimized placement of EPC network functions within the virtualization environment may include selection of virtualized PGW functions to support traffic flows of wireless devices served by the EPC network. The selection of virtualized PGW functions to support traffic flows of wireless devices served by the EPC network may be performed responsive to bearer requests for establishment of bearers for wireless devices served by the EPC network. Various embodiments may be further understood by way of reference to FIG. 1 and the exemplary embodiment of FIG. 4.

At step 299, method 200 ends.

FIGS. 3A and 3B depict an example in which the management system of FIG. 1 supports placement of EPC network functions within a virtualization environment in accordance with the method of FIG. 2. As depicted in FIGS. 3A and 3B, Topology Manager 141 and Orchestrator Module 142 (which form part of ENFMS 140 in FIG. 1) cooperate to support placement of EPC network functions within a virtualization environment.

As depicted in FIG. 3A, Orchestrator Module 142 receives input information and determines an optimized placement of EPC network functions within the virtualization environment based on the input information.

The input information includes EPC network requirements to be satisfied by the EPC network functions (denoted as EPC network requirements 311). In the example of FIG. 3A, the EPC network requirements 311 include 5 units of PGW capability, 3 units of SGW capability, and 9 units of MME capability. The “units” of the EPC network requirements 311 for a given EPC network function may be defined based on one or more requirements of the EPC network function which, it will be appreciated, may vary across different types of EPC network functions. For example, the “units” of the EPC network requirements 311 for a given EPC network function may be defined based on one or more of an input/output capacity to be supported, a number of transactions to be supported (e.g., a total number of transactions to be supported, a number of transactions per second to be supported, or the like), a packet rate to be supported, a number of packets to be supported, a number of sessions to be supported, or a number of users to be supported. It will be appreciated that the EPC network requirements 311 may include less or more requirements for the types of EPC network functions listed, requirements for other types of EPC network functions, and so forth.

The input information includes information associated with potential placement locations for the EPC network functions (denoted as potential location information 312). In the example of FIG. 3A, the potential location information 312 includes potential location information for a first location (denoted as Location A and having 22 units of 8CPU processing capability, 32 GB of RAM, 12 units of 16CPU processing capability, 64 GB of RAM, 1 SAN with 1.2 TB disk, and so forth) and potential location information for a second location (denoted as Location B and having 32 units of 8CPU processing capability, 32 GB of RAM, 110 units of 16CPU processing capability, 64 GB of RAM, 1 SAN with 1.2 TB disk, and so forth). It will be appreciated that the potential location information 312 may include various other types of information, may include information for fewer or more potential locations, may be provided at other levels of granularity, and so forth.

The input information includes resource requirements for the EPC network functions, which may be in the form of EPC virtualization profiles which indicate an amount of virtualization resources needed to support an associated capacity of the EPC network function to be supported (denoted as EPC virtualization profiles 313). In the example of FIG. 3A, the EPC virtualization profiles 313 include two EPC virtualization profiles for an MME function and two EPC virtualization profiles for a PGW function. The EPC virtualization profiles 313 include, for the MME function, (1) a first profile for supporting 1 unit of MME capacity which indicates virtual resource requirements of a 2CPU processing capability, 4 GB of RAM, and 16 GB of disk space to support 1 unit of MME capacity, and (2) a second profile for supporting 4 units of MME capacity which indicates virtual resource requirements of a 6CPU processing capability, 8 GB of RAM, and 16 GB of disk space to support 4 units of MME capacity. The EPC virtualization profiles 313 include, for the PGW function, (1) a first profile for supporting 1 unit of PGW capacity which indicates virtual resource requirements of a 4CPU processing capability, 8 GB of RAM, and 16 GB of disk space to support 1 unit of PGW capacity, and (2) a second profile for supporting 4 units of PGW capacity which indicates virtual resource requirements of an 8CPU processing capability, 8 GB of RAM, and 32 GB of disk space to support 4 units of PGW capacity. It will be appreciated that, although primarily presented with respect to examples in which a unit profile includes only a single VM, in at least some embodiments a unit profile may include multiple VMs (e.g., a 4 unit MME profile may require two sets (VMs) of 3CPU processing capability, 8 GB of RAM, and 16 GB of disk space; an 8 unit SGW profile may require four sets (VMs) of 2CPU processing capability, 8 GB of RAM, and 8 GB of disk space; and so forth). It will be appreciated that the EPC virtualization profiles 313 may include profiles for fewer or more EPC functions, fewer or more EPC virtualization profiles for one or more EPC functions, and so forth.

The input information includes costs associated with placement of EPC network functions within the virtualization environment (denoted as cost information 314). In the example of FIG. 3A, the cost information 314 includes provisioned bandwidth information, latency information, or the like, as well as various combinations thereof (although it will be appreciated that less or more, as well as different types, of cost information may be used). As depicted in FIG. 3A, the cost information 314 is received at Orchestrator Module 142 from Topology Manager 141.

As depicted in FIG. 3B, Orchestrator Module 142 configures the virtualization environment to support the optimized placement of EPC network functions within the virtualization environment.

As depicted in FIG. 3A, the EPC network requirements 311 indicate a need for 5 units of PGW capability within the virtualization environment and the EPC virtualization profiles 313 indicate that 4 units of PGW capability may be provided using a profile for supporting 4 units of PGW capacity and that 1 unit of PGW capability may be provided using a profile for supporting 1 unit of PGW capacity. As such, as depicted in FIG. 3B, the Orchestrator Module 142 configures the virtualization environment to support 5 units of PGW capability by: (1) at Location A, creating a PGW VM in accordance with the second profile for supporting 4 units of PGW capacity (which, as depicted in FIG. 3A, has virtual resource requirements of an 8CPU processing capability, 8 GB of RAM, and 32 GB of disk space to support 4 units of PGW capacity) and (2) at Location B, creating a PGW VM in accordance with the first profile for supporting 1 unit of PGW capacity (which, as depicted in FIG. 3A, has virtual resource requirements of a 4CPU processing capability, 8 GB of RAM, and 16 GB of disk space to support 1 unit of PGW capacity).

As depicted in FIG. 3A, the EPC network requirements 311 indicate a need for 3 units of SGW capability within the virtualization environment. As such, as depicted in FIG. 3B, the Orchestrator Module 142 configures the virtualization environment to support 3 units of SGW capability by: (1) at Location A, creating an SGW VM in accordance with a profile for supporting 3 units of SGW capacity (where such profile was omitted from FIG. 3A for purposes of clarity) and (2) at Location B, removing an existing SGW VM (identified by the Orchestrator Module 142 as having an identifier of XYZ).

It will be appreciated that configuration of the virtualization environment to support the optimized placement of EPC network functions within the virtualization environment may include various other configuration actions which may be performed for various other EPC network functions to be supported.

FIG. 4 depicts an exemplary embodiment of a method for supporting use of EPC network functions placed within a virtualization environment. As depicted in FIG. 4, method 400 is described within the context of portions of wireless communication system 100 of FIG. 1, illustrating a manner in which Orchestrator Module 142 enables traffic of a WD 110 to flow through the proper EPC network functions which have been placed within the VE 130 to form the virtualized EPC network functions 131. It will be appreciated that, although presented as being performed serially, at least a portion of the steps of method 400 may be performed contemporaneously or in a different order than as presented in FIG. 4.

At step 405, method 400 begins when the MME receives a bearer request from eNodeB 121 and interfaces to the HSS responsive to the bearer request from eNodeB 121. The bearer request may be initiated in response to a PDN attach operation, in response to a bearer setup operation, or the like. The bearer request may be initiated in response to a request received from the WD 110. This may be performed as per 3GPP TS 29.303 or in any other suitable manner.

At step 410, the HSS queries Orchestrator Module 142 for the proper PGW to be used for optimized traffic flow for WD 110.

At step 415, Orchestrator Module 142 determines the optimal PGW to use for optimized traffic flow for WD 110. The Orchestrator Module may determine the optimal PGW to use for optimized traffic flow for WD 110 based on a device characteristic(s) of WD 110, information indicative of previous flow behavior of one or more previous traffic flows of WD 110, information indicative of previous flow patterns of previous traffic flows of WD 110, system status information for wireless communication system 100 (e.g., load, congestion, or the like), or the like, as well as various combinations thereof.

At step 420, Orchestrator Module 142 provides PGW identification information to the HSS. The PGW identification information identifies the optimal PGW to use for optimized traffic flow for WD 110. The PGW identification information may be an IP address (e.g., of the VM that is providing the PGW function), a Fully Qualified Domain Name (FQDN), or any other suitable type of PGW identification information.

At step 425, the HSS provides the PGW identification information of the optimal PGW to the MME. The HSS may provide the PGW identification information of the optimal PGW to the MME based on 3GPP TS 29.303 and 3GPP TS 23.401 or in any other suitable manner.

At step 430, the MME resolves the PGW identification information of the optimal PGW by querying the DNS. The MME may resolve the PGW identification information of the optimal PGW by querying the DNS based on 3GPP TS 29.303 or in any other suitable manner.

At step 435, the MME instructs the eNodeB 121 to setup the traffic flow to a SGW (e.g., the closest SGW) for the eNodeB 121 and to the optimal PGW specified by the HSS. The MME may instruct the eNodeB 121 as per 3GPP standards or in any other suitable manner.

At step 440, traffic flows via eNodeB 121, the SGW, and the optimal PGW. The use of the path including eNodeB 121, the SGW, and the optimal PGW for the traffic flow from WD 110 provides or tends to provide one or more optimizations (e.g., cost optimization, performance optimization, or the like) in the EPC network that is virtualized within VE 130.

It will be appreciated that, although omitted from FIG. 4 for purposes of clarity, in at least some embodiments the Orchestrator Module 142 may use at least one of subscriber context information (e.g., location, past history, or the like) and network context information (e.g., congestion/past history of congestion) to determine the optimum PGW to use for optimized traffic flow for WD 110.

It will be appreciated that, although omitted from FIG. 4 for purposes of clarity, in at least some embodiments, rather than the HSS interfacing to the Orchestrator Module 142 (illustratively, steps 410 and 420), the MME may query the Orchestrator Module 142 to determine the proper SGW and optimal PGW to use for optimized traffic flow for WD 110.

It will be appreciated that, although omitted from FIG. 4 for purposes of clarity, in at least some embodiments, rather than the HSS interfacing to the Orchestrator Module 142 (illustratively, steps 410 and 420), the DNS, when providing resolution for the optimal PGW, may interface with the Orchestrator Module 142 to determine the proper SGW and optimal PGW to use for optimized traffic flow for WD 110.

It will be appreciated that, although primarily presented with respect to placement and use of specific EPC network functions, various embodiments of the capability for controlling placement and use of EPC network functions within a virtualization environment may be applied for controlling placement and use of other implementations of EPC network functions, other types of EPC network functions, EPC network function enhancements, or the like, as well as various combinations thereof. For example, the capability for controlling placement and use of EPC network functions within a virtualization environment may be used to perform dynamic placement and use of local gateways (e.g., L-PGWs) which may be used for Selective IP Offloading (e.g., offloading selected traffic for the Mobile Operator such that the traffic does not need to pass through the core network of the Mobile Operator).

Various embodiments of the capability for controlling placement and use of EPC network functions within a virtualization environment may provide various advantages. In at least some embodiments, the capability for controlling placement and use of EPC network functions within a virtualization environment, due at least in part to consideration of the flexibility provided by virtualization in conjunction with dynamic information (e.g., network topology information, cost information, information indicative of individual user context, or the like), provides improved performance of the EPC network over the performance that would otherwise be attained with existing mechanisms for deployment of EPC network functions and at lower costs than would otherwise be attained with existing mechanisms for deployment of EPC network functions. In at least some embodiments, the capability for controlling placement and use of EPC network functions within a virtualization environment supports dynamic placement and use of EPC network functions, which may provide various advantages not currently possible with static deployment of EPC functions using physical EPC elements and which may not be possible with existing mechanisms for EPC virtualization. In at least some embodiments, the capability for controlling placement and use of EPC network functions within a virtualization environment supports dynamic placement and use of EPC network functions in a manner accounting for dynamic context information. In at least some embodiments, the capability for controlling placement and use of EPC network functions within a virtualization environment (as opposed to other mechanisms for deployment of EPC network functions in which the network planning organization does not adjust for changes in which may occur outside of the static planning intervals) supports dynamic placement and use of EPC network functions in a manner accounting for short or medium timescale changes of network topology, short or medium timescale changes of network costs, short to medium timescale changes of network traffic (e.g., traffic volume, traffic patterns, or the like), or the like. Various embodiments of the capability for controlling placement and use of elements of an EPC network may provide various other advantages.

It will be appreciated that, although primarily presented herein with respect to embodiments for controlling placement and use of wireless network functions within a virtualization environment for a specific type of wireless network (namely, an EPC network of an LTE-based wireless system), various embodiments presented herein for controlling placement and use of wireless network functions within a virtualization environment may be applied or adapted for controlling placement and use of wireless network functions within a virtualization environment for various other types of wireless networks (e.g., a General Packet Radio Service (GPRS) network portion of GPRS which may be used as part of the Second Generation (2G) Global System for Mobile (GSM) or the Third Generation (3G) Universal Mobile Telecommunications System (UMTS), a core network portion of a Code Division Multiple Access 2000 (CDMA2000) system, or the like). For example, various embodiments presented herein for controlling placement and use of wireless network functions within a virtualization environment may be applied or adapted for controlling placement and use of GPRS core network functions such as Serving GPRS Support Node (SGSN) functions, Gateway GPRS Support Node (GGSN) functions, Home Subscriber Server (HSS) functions, Home Location Register (HLR) functions, or the like. Accordingly, in at least some embodiments, references herein to EPC-specific terms (e.g., EPC network functions, SGW functions, PGW functions, and so forth) may be read more generally (e.g., wireless network functions, serving node functions, gateway node functions, and so forth, respectively).

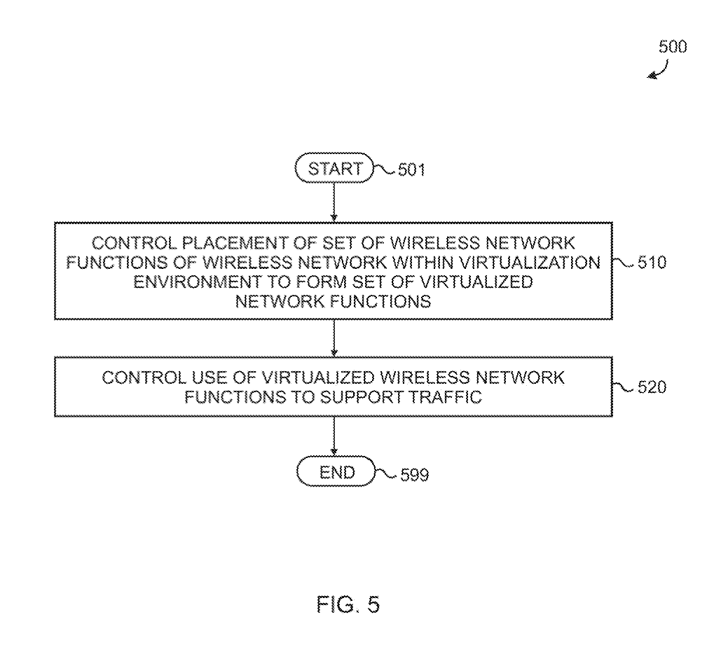

FIG. 5 depicts an exemplary embodiment of a method for supporting placement and use of wireless network functions of a wireless network within a virtualization environment. It will be appreciated that, although presented as being performed serially, at least a portion of the steps of method 500 may be performed contemporaneously or in a different order than as presented in FIG. 5. At step 501, method 500 begins. At step 510, placement of wireless network functions of the wireless network within the virtualization environment is controlled. The placement of wireless network functions of the wireless network within the virtualization environment forms a set of virtualized wireless network functions for the wireless network. The virtualized wireless network functions may include at least a set of virtualized serving node functions (e.g., virtualized SGSNs, virtualized SGWs, or the like) and a set of virtualized gateway node functions (e.g., virtualized GGSNs, virtualized PGWs, or the like). At step 520, use of the virtualized wireless network functions of the wireless network within the virtualization environment to support traffic is controlled. Control over the use of the virtualized wireless network functions of the wireless network within the virtualization environment to support traffic may include controlling selection of one of the virtualized gateway node functions responsive to a request for a bearer for a wireless device served by the wireless network. At step 599, method 500 ends. The steps of method 500 may be further understood when considered in conjunction with FIGS. 1-4.

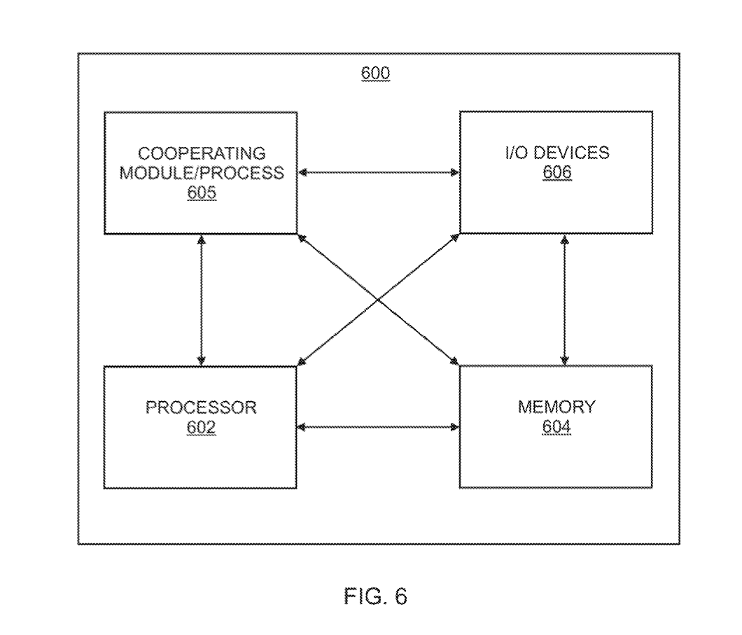

FIG. 6 depicts a high-level block diagram of a computer suitable for use in performing functions described herein.

The computer 600 includes a processor 602 (e.g., a central processing unit (CPU) and/or other suitable processor(s)) and a memory 604 (e.g., random access memory (RAM), read only memory (ROM), and the like).

The computer 600 also may include a cooperating module/process 605. The cooperating process 605 can be loaded into memory 604 and executed by the processor 602 to implement functions as discussed herein and, thus, cooperating process 605 (including associated data structures) can be stored on a computer readable storage medium, e.g., RAM memory, magnetic or optical drive or diskette, and the like.

The computer 600 also may include one or more input/output devices 606 (e.g., a user input device (such as a keyboard, a keypad, a mouse, and the like), a user output device (such as a display, a speaker, and the like), an input port, an output port, a receiver, a transmitter, one or more storage devices (e.g., a tape drive, a floppy drive, a hard disk drive, a compact disk drive, and the like), or the like, as well as various combinations thereof).

It will be appreciated that computer 600 depicted in FIG. 6 provides a general architecture and functionality suitable for implementing functional elements described herein and/or portions of functional elements described herein. For example, the computer 600 provides a general architecture and functionality suitable for implementing one or more of a WD 110 or a portion of a WD 110, an element of AN 120 or a portion of an element of AN 120, an eNodeB 121 or a portion of an eNodeB 121, an element of VE 130 or a portion of an element of VE 130, ENFMS 140 or a portion of ENFMS 140, Topology Manager 141 of a portion of Topology Manager 141, Orchestrator Module 142 or a portion of Orchestrator Module 142, or the like.

It will be appreciated that the functions depicted and described herein may be implemented in software (e.g., via implementation of software on one or more processors, for executing on a general purpose computer (e.g., via execution by one or more processors) so as to implement a special purpose computer, and the like) and/or may be implemented in hardware (e.g., using a general purpose computer, one or more application specific integrated circuits (ASIC), and/or any other hardware equivalents).

It will be appreciated that at least some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media such as non-transitory computer-readable storage media, transmitted via a data stream in a broadcast or other signal bearing medium, and/or stored within a memory within a computing device operating according to the instructions.

It will be appreciated that the term “or” as used herein refers to a non-exclusive “or,” unless otherwise indicated (e.g., use of “or else” or “or in the alternative”).

It will be appreciated that, although various embodiments which incorporate the teachings presented herein have been shown and described in detail herein, those skilled in the art can readily devise many other varied embodiments that still incorporate these teachings.

What is claimed is:

1. An apparatus, comprising:
a processor and a memory communicatively connected to the processor, the processor configured to:
control placement of a set of wireless network functions of a wireless network within a virtualization environment to form a set of virtualized wireless network functions, the set of virtualized wireless network functions including at least a set of virtualized serving node functions and a set of virtualized gateway node functions; and
control selection of one of the virtualized gateway node functions responsive to a request for a bearer for a wireless device served by the wireless network.

2. The apparatus of claim 1, wherein, to control placement of the set of wireless network functions of the wireless network within the virtualization environment, the processor is configured to:
determine a placement of the set of wireless network functions within the virtualization environment; and
configure the virtualization environment to support the determined placement of the set of wireless network functions with the virtualization environment.

3. The apparatus of claim 2, wherein the determined placement of the set of wireless network functions with the virtualization environment comprises a mapping of the set of wireless network functions onto physical resources of the virtualization environment.

4. The apparatus of claim 2, wherein, to configure the virtualization environment to support the determined placement of the set of wireless network functions with the virtualization environment, the processor is configured to
determine a current placement of the set of wireless network functions within the virtualization environment;
perform a comparison for comparing the determined placement of the set of wireless network functions within the virtualization environment and the current placement of the set of wireless network functions within the virtualization environment; and
configure the virtualization environment to support the determined placement of the set of wireless network functions with the virtualization environment based on the comparison for comparing the determined placement of the set of wireless network functions within the virtualization environment and the current placement of the set of wireless network functions within the virtualization environment.

5. The apparatus of claim 1, wherein the processor is configured to control placement of the set of wireless network functions within the virtualization environment based on wireless network function requirements comprising, for at least one of the wireless network functions, a number of units of the wireless network function to be supported.

6. The apparatus of claim 5, wherein the number of units of wireless network function to be supported is based on at least one of an input/output capacity to be supported, a number of transactions to be supported, a packet rate to be supported, a number of packets to be supported, a number of sessions to be supported, or a number of users to be supported.

7. The apparatus of claim 1, wherein the processor is configured to control the placement of the set of wireless network functions within the virtualization environment based on potential location information, wherein for at least one potential location of the virtualization environment, the potential location information comprises at least one of a geographic location of the potential location of the virtualization environment or an indication of physical resources available at the potential location of the virtualization environment.

8. The apparatus of claim 7, wherein the indication of physical resources available at the potential location of the virtualization environment comprises at least one of an indication of an amount of available processing resources, an indication of an amount of available memory resources, an indication of an amount of available storage resources, an indication of an amount of available input/output resources, or an indication of an amount of available networking resources.

9. The apparatus of claim 1, wherein the processor is configured to control the placement of the set of wireless network functions within the virtualization environment based on wireless network function virtualization profile information comprising, for at least one of the wireless network functions, a mapping between a number of units of the wireless network function to be supported and an amount of physical resources of the virtualization environment required to support the number of units of the wireless network function.

10. The apparatus of claim 9, wherein the number of units of the wireless network function to be supported is based on at least one of an input/output capacity to be supported, a number of transactions to be supported, a packet rate to be supported, a number of packets to be supported, a number of sessions to be supported, or a number of users to be supported.

11. The apparatus of claim 1, wherein the processor is configured to control the placement of the set of wireless network functions within the virtualization environment based on cost information.

12. The apparatus of claim 11, wherein the cost information comprises provisioned bandwidth information or latency information.

13. The apparatus of claim 1, wherein, to control selection of one of the virtualized gateway node functions, the processor is configured to:
receive, from a network element, a request for identification of one of the virtualized gateway node functions to be used for the bearer for the wireless device;
select the one of the virtualized gateway node functions to be used for the bearer for the wireless device; and
propagate, toward the network element, information identifying the one of the virtualized gateway node functions to be used for the bearer for the wireless device.

14. The apparatus of claim 13, wherein the network element comprises a home subscriber server, a mobility management entity, or a domain name server.

15. The apparatus of claim 13, wherein the request for identification of one of the virtualized gateway node functions to be used for the bearer for the wireless device is associated with at least one of an attach operation or a bearer setup operation.

16. The apparatus of claim 13, wherein the processor is configured to select the one of the virtualized gateway node functions to be used for the bearer for the wireless device based on at least one of a device characteristic of the wireless device, a traffic flow behavior of a previous traffic flow of the wireless device, a traffic flow pattern of a set of previous traffic flows of the wireless device, a subscriber context associated with the wireless device, or a network context associated with the wireless network.

17. The apparatus of claim 13, wherein the information identifying the one of the virtualized gateway node functions to be used for the bearer for the wireless device comprises at least one of an address or a fully qualified domain name.

18. The apparatus of claim 1, wherein the processor is configured to:
control selection of one of the virtualized serving node functions for the bearer for the wireless device.

19. The apparatus of claim 18, wherein, to control selection of one of the virtualized serving node functions, the processor is configured to:
receive, from a network element, a request for identification of one of the virtualized serving node functions to be used for the bearer for the wireless device;
select the one of the virtualized serving node functions to be used for the bearer for the wireless device; and
propagate, toward the network element, information identifying the one of the virtualized serving node functions to be used for the bearer for the wireless device.

20. A method, comprising:
controlling, via a processor and a memory, placement of a set of wireless network functions of a wireless network within a virtualization environment to form a set of virtualized wireless network functions, the set of virtualized wireless network functions including at least a set of virtualized serving node functions and a set of virtualized gateway node functions; and
controlling selection of one of the virtualized gateway node functions responsive to a request for a bearer for a wireless device served by the wireless network.

21. A non-transitory computer-readable storage medium storing instructions which, when executed by a computer, cause the computer to perform a method, the method comprising:
controlling placement of a set of wireless network functions of a wireless network within a virtualization environment to form a set of virtualized wireless network functions, the set of virtualized wireless network functions including at least a set of virtualized serving node functions and a set of virtualized gateway node functions; and
controlling selection of one of the virtualized gateway node functions responsive to a request for a bearer for a wireless device served by the wireless network.
